(19) United States
(12) Patent Application Publication
(10) Pub. No.: US 2008/0182621 A1
(43) Pub. Date: Jul. 31, 2008

(54) SIM APPLICATION TOOLKIT APPLICATION TO TRACK PHONE USAGE AND LOCATION

(75) Inventor: Robert C. Morman, Apex, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/669,638

(22) Filed: Jan. 31, 2007

(51) Int. Cl. H04M 1/00; H04Q 7/32; G06F 15/16

(52) U.S. Cl. 455/558; 709/203; 455/456.6

(57) ABSTRACT

A portable communication device includes a subscriber identity module (SIM) card having a memory and a processor, a device-activity SIM application toolkit (SAT) application stored on the memory. When the device-activity SAT application is accessed by the processor and executed, the device-activity SAT application causes the SIM card to interface with the portable communication track device communication activity and/or device location, store device-activity data representative of the tracked device communication activity and/or device location, and upload the device-activity data to a remote device-activity server. The device-activity SAT application facilitates access to instantaneous device-activity data via device-activity data collection and uploading to a remote server accessible via the Internet.

### TECHNICAL FIELD OF THE INVENTION

The present invention relates generally to portable communication devices, and, more particularly, to a portable communication device and method for tracking device activity.

### DESCRIPTION OF RELATED ART

Portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide services beyond voice services. The wireless industry is experiencing a rapid expansion of mobile data services and enhanced functionality. In addition, the features associated with certain types of portable communication devices have become increasingly diverse. To name a few examples, may portable communication devices have text messaging capability, Internet browsing functionality, e-mail capability, video playback capability, audio playback capability, image display capability and hands-free capability.

Increasingly, mobile phones also are equipped with removable memory. One such type of removable memory is a smart card, which also may be referred to as a Subscriber Identity Module (SIM) card. A SIM card is a smart card that securely stores identification information related to the portable communication device user, as well as the user's preferences, contact list, media, phone number, etc. The SIM card allows the user to switch portable communication devices easily by simply removing the SIM card from one portable communication device and placing it into a different portable communication device.

SIM cards also store network specific information to authenticate and identify subscribers on the network. Such information includes the International Circuit Card ID (ICCID) of the card, International Mobile Subscriber Identity (IMSI), Authentication Key (Ki) and Local Area Identity (LAI). Other information that can be stored on the SIM card includes carrier specific data such as the Short Message Service Center (SMSC) number, Service Provider Name (SPN), Service Dialing Numbers (SDN), and Value Added Service (VAS) applications. The equivalent of a SIM in the Universal Mobile Telecommunications System (UMTS) is a Universal SIM (USIM), and a Removable User Identity Module (RUIM) is more popular in the Core Division Multiple Access (CDMA) networks.

### SUMMARY

In view of the foregoing, a need exists for additional mobile data services, and application programs for providing additional mobile data services, such as a device-activity subscriber identity module (SIM) application toolkit (SAT) application that facilitates access to instantaneous device-activity data via automatic collection and uploading of device-activity data to a remote server accessible via the Internet.

One aspect of the technology relates to a portable communication device that includes a subscriber identity module (SIM) card having a memory and a processor and a device-activity SIM application toolkit (SAT) application stored on the memory. When the SAT application is accessed by the processor and executed, the device-activity SAT application causes the SIM card to interface with the portable communication device to track device communication activity and/or device location, store device-activity data representative of the tracked device communication activity and/or device location, and upload the device-activity data to a remote device-activity server.

According to another aspect, the device-activity SAT application causes the SIM card to upload by commanding the portable communication device to initiate a communication session with the remote device-activity server.

According to another aspect, the device-activity SAT application causes the SIM card to categorize the device-activity data.

According to another aspect, the device-activity data is categorized according to at least one of: outgoing communications data from the portable communication device, incoming communications to the portable communication device, data stored on the portable communication device, and/or a location corresponding to communications made by and/or made to the portable communication device.

According to another aspect, the portable device is a mobile telephone.

Another aspect of the technology relates to a method of creating a device-activity profile associated with a portable communication device. The method includes tracking device communication activity and/or device location, storing device-activity data representative of the tracked device communication activity and/or device location, and uploading the device-activity data to a remote device-activity server.

According to another aspect, the device-activity data is stored on a local memory.

According to another aspect, the local memory is a memory associated with a subscriber identity module (SIM) card.

According to another aspect, the method is carried out via a device-activity SIM application toolkit (SAT) application stored on a SIM card associated with the portable communication device.

According to another aspect, the remote device-activity server is accessible via the Internet.

According to another aspect, the device-activity data is categorized according to at least one of: outgoing communications data from the portable communication device, incoming communications to the portable communication device, data stored on the portable communication device, and/or a location corresponding to communications made by and/or made to the portable communication device.

According to another aspect, the method includes displaying the categorized device-activity data in a user-readable format.

According to another aspect, the portable communication device is a mobile telephone.

Another aspect of the technology relates to a method of creating a device-activity profile for a portable communication device that includes receiving device-activity data from a subscriber identity module (SIM) associated with the portable communication device, and organizing the received device-activity data into a predefined format for display on a user-readable display.

According to another aspect, the method includes receiving a request for the device-activity data and displaying the device-activity data in the predefined format on a user-readable display.

According to another aspect, organizing the device-activity data includes categorizing the device-activity data according to at least one of: outgoing communications data from the portable communication device, incoming communications to the portable communication device, data stored on the portable communication device, and/or a location corresponding to communications made by and/or made to the portable communication device

According to another aspect, the portable communication device is a mobile telephone.

Another aspect of the technology relates to an application toolkit stored on a machine-readable medium on a subscriber identity module (SIM) card, wherein when the application toolkit is accessed by the SIM card and executed, causes the SIM card to interface with a portable communication device to: track communication activity and/or location of the portable communication device, store device-activity data representative of the tracked communication activity and/or device location of the portable communication device, and upload the device-activity data to a remote device-activity server.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system including a portable communication device on which aspects of the technology may be carried out;

FIG. 2 is a diagrammatic illustration of a portable communication device equipped with a device-activity SIM application toolkit application;

FIG. 3 is a flow chart or functional diagram representing a method of the relevant operation of a portable communication device running a device-activity SIM application toolkit application; and

FIG. 4 is a flow chart or functional diagram representing a method of creating a device-activity profile for a portable communication device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

The present disclosure describes a device-activity subscriber identity module (SIM) application toolkit (SAT) (referred to below as a device-activity SAT application) that facilitates automatic collection and uploading of device-activity data to a remote server accessible via the Internet. This functionality provides the portable communication device user (or an interested and authorized third party) with access to instantaneous device-activity data associated with the portable communication device.

As used herein, the term “portable communication device” includes portable radio communication equipment. The term “portable radio communication equipment,” which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used for voice and/or data communication.

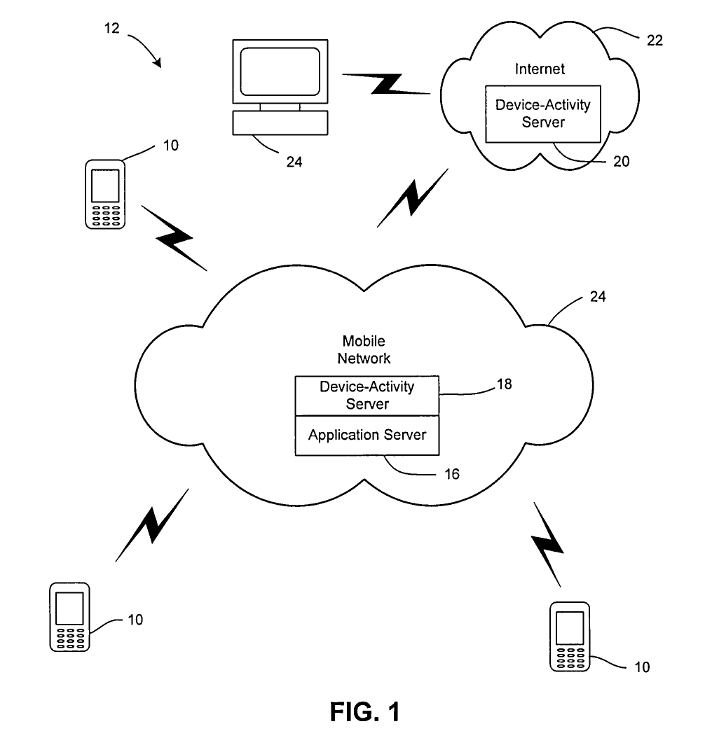

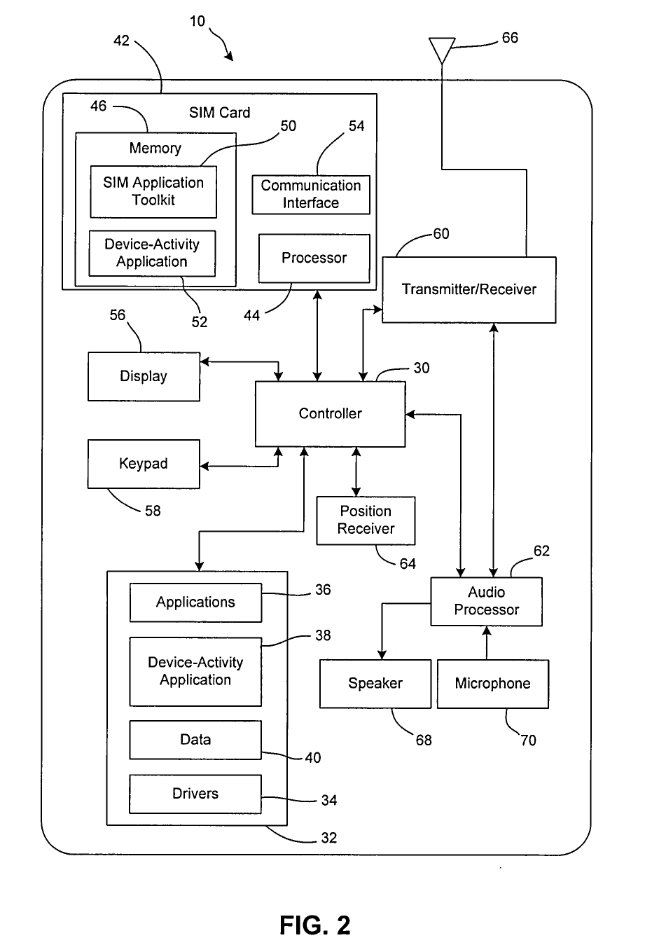

Referring initially to FIGS. 1-2, an exemplary embodiment of a portable communication device 10 (e.g., a mobile phone, mobile terminal or the like) is depicted. As is described more fully below, the portable communication device 10 is equipped with a device-activity SAT application stored on a local memory (e.g., a SIM card memory) and executed by a local processor (e.g., a SIM card processor) to track device activity and/or device location. The device-activity data may be captured or otherwise stored and uploaded to a remote device-activity server (e.g., a remote server accessible via the Internet).

The portable communication device in the illustrated embodiments is a mobile telephone, and may be referred to as the mobile telephone 10. As indicated, the description and illustrations of a mobile telephone for the portable communication device are intended to serve as a non-limiting exemplary environment for the inventive concepts described herein. The mobile telephone 10 is shown as having a “brick” or “block” form factor housing, but it will be appreciated that other types of housings, such as a clamshell housing or a slide-housing, etc., may be utilized.

Referring to FIG. 1, the portable communication device 10 may be configured to operate as part of a communication system 12. The communication system includes a mobile network 14, such as a mobile cellular telephony network, that facilitates communication, such as voice communication and/or data transfer between a plurality of portable communication devices 10, such as mobile phones, mobile terminals or the like. The mobile network 14 includes or accesses one or more servers (referred to generally as application server 16) for managing calls placed by and destined to the portable communication device 10, as well as supporting one or more applications (e.g., a device-activity application) by (e.g., including appropriate hardware and/or application programs for collecting and uploading device-activity data).

In the illustrated embodiment, the mobile network 14 also includes or accesses at least one device-activity server 18, 20. In one embodiment, the device-activity server (indicated by reference 18) may be a part of the mobile network 14. Alternatively or additionally, the device-activity server (indicated by reference 20) may be remote to the mobile network. As is described more fully below, the device-activity server(s) 18 and/or 20 are in data communication with the portable communication device 10 for receipt of uploaded device-activity data. Either device activity server 18 or 20 will be accessible by a user via the user's portable communication device and/or by the user (or an interested and authorized third party) via the Internet 22 (e.g., using a computer terminal 24).

It will be appreciated that the mobile network 14 includes a network infrastructure, portions of which are used or otherwise accessed by the portable communication devices. The portable communication devices 10 may interact with each other and/or the network infrastructure in accordance with any suitable communication standard, e.g., the Global System for Mobile Communications (GSM) standard. Other suitable communication standards include, but are not limited to, Advanced Mobile Phone Service (AMPS), Digital Advanced Mobile Phone Service (D-AMPS), General Packet Radio Service (GPRS), Universal Mobile Telecommunications System (UMTS), Code Division Multiple Access (CDMA), Voice-Over IP (VoIP), Session Initiated Protocol (SIP), Wireless Local Area Network (WLAN) or the like. In other words, the communication system shown in FIG. 1 is provided for purposes of explaining aspects of the present invention, without limiting the invention to a particular communication system design, architecture or communication standard.

FIG. 2 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

The memory 32 stores drivers 34 (e.g., I/O device drivers), application programs 36, optionally including a device-activity application program 38, and application program data 40. The I/O device drivers include software routines that are accessed through the controller 30 (or by an operating system (not shown) stored in memory 32) by the application programs to communicate with devices such as a display 56 and keypad 58 (e.g., a standard keypad, a QWERT keypad or a touch screen keypad) as well as other input/output ports.

The application programs 36, including the device-activity application program 38, comprise programs that implement various features of the portable communication device 10, such as voice calls, e-mail, Internet access, contact manager and the like. As is described more fully below, the device-activity application program 38 (whether it be embodied or stored on memory 32 or on the below-described memory associated with the SIM card) comprises a program, logic routine or code that enables the user to create and/or manage a device-activity data, including device communication activity and/or device location data, etc., or other data that a user may desire to track.

A person having ordinary skill in the art of computer programming, and specifically in applications programming for mobile phones, will consider it obvious in view of the description provided herein how to program a mobile phone to operate and carry out the functions described herein with respect to the device-activity application program 38 (and any interfacing between the device-activity profile application program 38 and other application programs 40 (e.g., messaging application programs, media application programs and the like). Accordingly, details as to the specific programming code have been left out. Also, while the search functionality is carried out via the controller 38 and device-activity application program 38 (alone or in conjunction with other application programs) in memory 32 in accordance with inventive aspects, such function also could be carried out via dedicated hardware, firmware, software or combinations thereof without departing from the scope of the present invention.

In the illustrated embodiment, the portable communication device 10 includes or otherwise is equipped with a subscriber identity module (SIM) 42 (also referred to as a SIM card or a smart card). SIM card 42 is one example of a removable memory card. Other suitable smart cards may be employed, including, but not limited to a Universal SIM (USIM) and a Removable User Identity Module (RUIM). The SIM card 42 shown in FIG. 2 is provided for purposes of explaining aspects of the present invention, without limiting the invention to a smart card architecture or communication standard.

The SIM card 42 generally includes a processor 44, memory 46 and a communication interface 48. The processor 44, e.g., a micro-controller integrated into a chip, controls the overall operation of the SIM card 42 (as well as its interaction of the portable communication device 10). Memory 46, e.g., an EEPROM or other suitable memory unit, is operatively connected to the processor 44 for storing control programs and data related to operation of the SIM card 42 and its interaction with the portable communication device 10. The memory 46 stores various application programs, e.g., a SIM Application Toolkit (SAT) 50. The SAT 50 includes a set of commands programmed into the SIM card 42 that define how the SIM card 42 should interact with the outside world, e.g., the mobile telephone 10 and/or the mobile network, including the device-activity server 18, 20. The SAT 50 also allows the SIM card 42 to give commands to the mobile telephone handset, such as the display menu and also may request user input, such as, for example, an authentication key, a security passwords, etc.

In the illustrated embodiment, the SIM card 42 includes a device-activity SAT application 52 (also referred to as a device-activity application). While the device-activity SAT application 52 is shown as a separate application program stored on the SIM card 42, it is to be appreciated that the general SAT 50 may be configured to carry out the described device-activity SAT application functionality. As is described more fully below, the device-activity SAT application 52 includes a set of commands programmed into the SIM card 42 that define how the SIM card 42 functions (independent of or interfacing with the mobile telephone 10) to track, capture and upload to a remote device-activity server device activity data representative of the location and/or communication activity on the mobile phone.

In a preferred embodiment, the device-activity tracking functionality is achieved via the device-activity SAT application 52 controlling the SIM card 42 and its interaction with the mobile phone. Alternatively or additionally, the device tracking functionality may be accomplished via the device-activity application 38 (alone or in conjunction with the device-activity SAT application 52). In other words, while FIG. 2 shows the a device-activity application being loaded on both the mobile phone memory 32 (device-activity application program 38) and on the SIM card memory 46 (device-activity SAT application 52), it will be appreciated, however, that the device-activity application need only be loaded on one of the local memories for carrying out the functions described herein.

The communication interface 54 facilitates communication (e.g., data transfer) between the SIM card 42 and the mobile telephone 10 and/or the mobile network. The communication interface 54 may facilitate communication and/or data transfer by establishing a data channel through the mobile telephone to a remote server (e.g., the device activity server 18 or 20 described above with respect to FIG. 1). The communication interface may facilitate communication and/or data transfer according any suitable communication protocol. For example, one such communication protocol is Bearer Independent Protocol (BIP). BIP allows the SIM card 42 to upload data from the SIM card memory 46 or download data from a remote server.

The communication interface 54 may be in active data communication with the outside world (e.g., the device-activity server) without any input or command from the user of the mobile phone. For example, the device-activity SAT application 52 may run in the background of the mobile telephone's operating system without requiring the user to initiate the application. The device-activity application will begin to track and capture the device-activity data as soon as the mobile telephone registers to the mobile network. For example, once the mobile phone 10 registers to the mobile network, the device-activity SAT application may determine which mobile radio tower the device is camped on, or may use global positioning to determine the exact location of the mobile phone 10 at any give time. The device-activity application then captures and/or stores the data for uploading to a remote server, as described in more detail below. The device activity application also may track other device-activity data, including the, the unique identifier of the portable communication devices that the mobile phone has been in contact with, the duration and location of calls and/or messages, and the content of the data stored on the phone, such as, for example, audio-visual media, text, video or picture messages, emails, contact lists, etc.

A person having ordinary skill in the art of computer programming, and specifically in applications programming for mobile phones, will consider it obvious in view of the description provided herein how to program a SIM card to operate and carry out the functions described herein with respect to the device-activity application program 52 (and any interfacing between the device-activity application program 52 and other application programs (e.g., messaging application programs, media application programs and the like) or the mobile phone 10, mobile network 14 and the like. Accordingly, details as to the specific programming code have been left out. Specifically, among other operating systems, two prominent operating systems are Native and Java. Native SIM card typically are based on proprietary, vendor-specific software, while Java SIM cards typically are based on the Java programming language and, therefore, are hardware independent. These two main operating systems, as well as others are well known by a person having ordinary skill in the art of computer programming and therefore for the sake of brevity the programming details are not described in further detail.

With continued reference to FIG. 2, the controller 30 interfaces with the aforementioned display 56 and keypad 58 (and any other user interface device(s)), a transmitter/receiver 60 (often referred to as a transceiver), audio processing circuitry, such as an audio processor 62, and a position determination element or position receiver 64, such as a global positioning system (GPS) receiver. The portable communication device 10 may include a camera that captures digital pictures and/or video. Image and/or video files corresponding to the pictures and/or video may be stored in memory 32 (e.g., in the case of video files, in a local media content database, which may be searched in accordance with the medial time controller functionality).

An antenna 66 is coupled to the transmitter/receiver 46 such that the transmitter/receiver 46 transmits and receives signals via antenna 46, as is conventional. The portable communication device includes an audio processor 62 for processing the audio signals transmitted by and received from the transmitter/receiver. Coupled to the audio processor 62 are a speaker 68 and microphone 70, which enable a user to listen and speak via the portable communication device. Audio data may be passed to the audio processor 62 for playback to the user. The audio data may include, for example, audio data from an audio file stored in the memory 32 and retrieved by the controller 30. The audio processor 62 may include any appropriate buffers, decoders, amplifiers and the like.

The portable communication device also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 60 may be representative of an interface suitable for communication within a cellular network or other wireless wide-area network (WWAN).

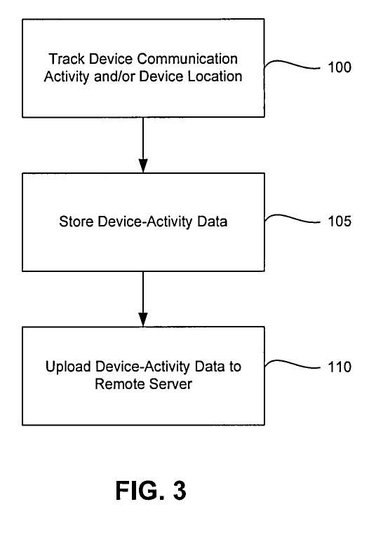

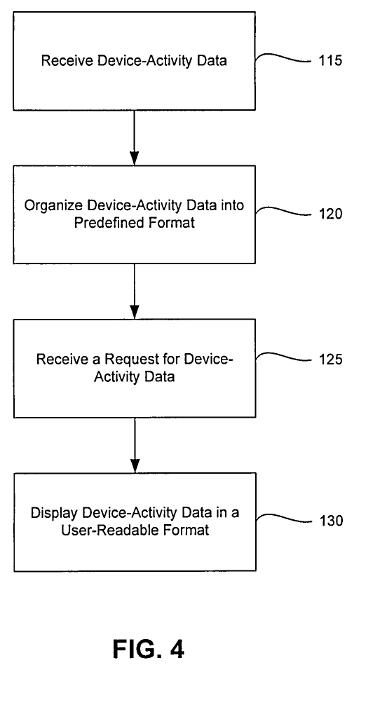

While for purposes of simplicity of explanation, the flow charts or functional diagrams in FIGS. 3-4 include a series of steps or functional blocks that represent one or more aspects of the relevant operation of the portable communication device 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIG. 3-4, which are implemented on or through a portable communication device, relate to a method of tracking activity related to the portable communication device (also referred to as a method of creating a device-activity profile associated with a portable communication device). As is noted above, although the method is described with respect to operations controlled by or otherwise carried out according to instructions from a device-activity SAT application 52 loaded or otherwise stored on the SIM card 42, it should be appreciated that the method described herein is equally applicable to the device-activity application 38 loaded on the local memory 32 of the portable communication device 10.

Turning now to FIG. 3, a method of creating a device-activity profile begins at functional block 100 where the portable communication device (e.g., via the SIM card 42, as programmed by the device-activity SAT application 52) tracks device communication activity and/or device location. In one embodiment, the tracked device communication activity includes calls made and calls received by the portable communication device. The device-activity SAT application also may track other device activity data, including, but not limited to, the unique identifier of the portable communication devices with which the mobile phone has been in contact, the duration and location of calls and/or messages, and the content of the data stored on the phone, such as, for example, audio-visual media, text, video or picture messages, emails, contact lists, etc.

Device location may be tracked along with device communication activity. In one embodiment, the device-activity SAT application directs device location tracking to track the cell tower on which the portable communication device is “camping.” Any other suitable location determination may be employed without departing from the scope of the present invention. For example, a suitable location determination mechanism may include accessing an identity of a communications access point (e.g., communications tower) servicing the mobile telephone 10 at a given time. For instance, the communications tower may be part of a cellular network (e.g., a “cell” tower) that has an associated identifier (e.g., “cell ID”) and the identifier is communicated to the mobile telephone 10.

Each identifier or cell ID in a particular servicing network may be assumed to be unique and, therefore, may be used to indicate relative proximity to a certain location. In one embodiment, the cell ID and any related radio parameters may be used to generate a coordinate value through a radio network service. For example, under global system mobile communications (GSM) and universal mobile telecommunications system (UMTS) protocols, the position could be estimated through a mobile originated location request (MO-LR) to the network so that the mobile telephone 10 position could be estimated using the network's knowledge of tower locations and antenna directions.

In other embodiments, location information may be determined by receipt of location data from a dedicated system, such as a global positioning satellite (GPS), Galileo satellite system or the like. Such data may be received via the position receiver 64, if present as part of the mobile telephone 10. For instance, GPS coordinates may be expressed using a standard reference system (e.g., the world geodetic system or WGS).

It will be appreciated that the device-activity data (e.g., data corresponding to or otherwise representative of device communication activity and/or device location) may be tracked by the SIM card 42 (as controlled by the device-activity SAT application 52) independently of the operation of the mobile telephone 10. In other words, the device-activity application runs in the background of the mobile telephone's operating system such that while the device-activity data is continuously tracked, captured and uploaded by the SIM card 42, the mobile telephone 10 continues to operate in a typical fashion.

The device-activity data tracked by the SIM card is captured or otherwise stored (e.g., within the memory 46 of the SIM card 42) at functional block 105. The capture and/or storage of the device-activity data is temporary and may be only for a brief moment before the data is uploaded to a remote server at functional block 110. For example, the data may be stored and accumulated on the SIM card memory 46 and then uploaded to the remote device-activity server as a group or bundle. Alternatively, storing the device-activity data may include instantaneous or near-instantaneous upload of the device-activity data to the remote server. Such functionality allows the SIM card 42 to track the real-time device-activity data of the mobile telephone 10. Alternatively or additionally, the device-activity data also may be captured and stored in the local memory 32 of the mobile phone 10, where it is stored until it is uploaded to the remote device-activity server.

At functional block 110, the device-activity data is uploaded to a remote server, such as, for example, the device-activity server 18 or 20 described above. The data is uploaded using the communication interface 54 of the SIM card, and, by way of example, using BIP for uploading via the mobile phones transmitter/receiver 60 and antenna 64. As is discussed more fully below, the uploaded device-activity data may be made available for viewing by the user and/or any interested (and authorized) third party.

Referring to FIG. 4, the functionality of the remote server, such as the device-activity server 18 or 20 is shown in more detail. As described above, the device-activity server 18 or 20 is configured to receive device-activity data uploaded by the SIM card 42, through the mobile phone's communication channel (by command from the device-activity SAT application). As shown in FIG. 4, upon establishing a data communication with the mobile telephone 10 or SIM card 42, the device-activity server receives the device-activity data that has been captured and/or stored, as commanded by the device-activity SAT application.

The device-activity data may then be organized and/or categorized by the remote server 18 at functional block 120. The data may be organized into any of a number of categories, non-limiting examples include: the time or content of the outgoing or incoming communications data, the data input by the user, data or text stored on the portable communication device, multi-media content and/or the location corresponding to communications made by and/or made to the portable communication device, etc. Alternatively, the received device-activity data may be organized and/or categorized into a predefined format before uploading based on commands from the device-activity SAT application.

At functional block 125, the device-activity server 18 or 20 receives a request for access to the device-activity data from a terminal, such as, for example, a computer terminal or a portable communication device, which may include the mobile phone whose device-activity data is tracked. The request may be received by the device-activity server via the Internet or may be received via the mobile network 14 as illustrated in FIG. 1. The request may include all of the data received and categorized by the device-activity server, or the request may be only for select information. The user or device requesting the device-activity data also may request a customized device-activity report, which may contain any of a number of different types of data that may be specified by the requester.

At functional block 130, the device-activity server formats the data requested from its native format (e.g., the format of the data as it was received from the mobile phone 10) into a user-readable format. Alternatively, the device-activity data may already be stored in a suitable predefined format. The user-readable format may then be displayed on a monitor or screen, or may be received by the requester via another means, for example, electronic mail and the like, etc. The requestor can then view the device-activity data to determine, for example, where and when the mobile telephone 10 is being used, including the real-time location of the mobile telephone 10. Other data that can be determined by the requestor includes, but is not limited to, the contents of the mobile phone contact list, text messages and the like.

The requester can then view the device-activity report on a computer monitor, the display of a portable communication device, etc., as is well known in the art.

It will be appreciated that a portable communication device equipped with the device-activity tracking functionality described herein provides the user with the capability of efficiently tracking, and, therefore gaining access to, instantaneous data concerning mobile phone usage and current geographic location (e.g., via the Internet).

Artisans will appreciate that this functionality may lend itself to a variety of commercial applications. One exemplary application is a parental tracking application in which a parent may visit a website to keep track of where their child is and with whom they have been communicating in real time. Another exemplary commercial application provides mobile phone users with a mechanism for tracking mobile phone usage without the need for an operator to open up access to their customer data. In this exemplary environment, the user may visit a website to track mobile phone usage without any operator interaction. Other commercial applications will become apparent to skilled artisans upon reading this disclosure.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for,” are not intended to be read as means-plus-function elements, even if the claim otherwise includes the word “means.”

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a subscriber identity module (SIM) card having a memory and a processor;
a device-activity SIM application toolkit (SAT) application stored on the memory, wherein when the SAT application is accessed by the processor and executed, the device-activity SAT application causes the SIM card to interface with the portable communication device to:
track device communication activity and/or device location;
store device-activity data representative of the tracked device communication activity and/or device location; and
upload the device-activity data to a remote device-activity server.

2. The portable communication device of claim 1, wherein the device-activity SAT application causes the SIM card to upload by commanding the portable communication device to initiate a communication session with the remote device-activity server.

3. The portable communication device of claim 1, wherein the device-activity SAT application causes the SIM card to categorize the device-activity data.

4. The portable communication device of claim 3, wherein the device-activity data is categorized according to at least one of: outgoing communications data from the portable communication device, incoming communications to the portable communication device, data stored on the portable communication device, and/or a location corresponding to communications made by and/or made to the portable communication device.

5. The portable communication device of claim 1, wherein the portable device is a mobile telephone.

6. A method of creating a device-activity profile associated with a portable communication device, the method comprising:
tracking device communication activity and/or device location;
storing device-activity data representative of the tracked device communication activity and/or device location; and
uploading the device-activity data to a remote device-activity server.

7. The method of claim 6, wherein the device-activity data is stored on a local memory.

8. The method of claim 7, wherein the local memory is a memory associated with a subscriber identity module (SIM) card.

9. The method of claim 7, wherein the method is carried out via a device-activity SIM application toolkit (SAT) application stored on a SIM card associated with the portable communication device.

10. The method of claim 6, wherein the remote device-activity server is accessible via the Internet.

11. The portable communication device of claim 3, wherein the device-activity data is categorized according to at least one of: outgoing communications data from the portable communication device, incoming communications to the portable communication device, data stored on the portable communication device, and/or a location corresponding to communications made by and/or made to the portable communication device.

12. The method of claim 11, further comprising displaying the categorized device-activity data in a user-readable format.

13. The method of claim 6, wherein the portable communication device is a mobile telephone.

14. A method of creating a device-activity profile for a portable communication device, the method comprising:
receiving device-activity data from a subscriber identity module (SIM) associated with the portable communication device; and
organizing the received device-activity data into a predefined format for display on a user-readable display.

15. The method of claim 14, further comprising:
receiving a request for the device-activity data; and
displaying the device-activity data in the predefined format on a user-readable display.

16. The portable communication device of claim 14, wherein organizing the device-activity data includes categorizing the device-activity data according to at least one of: outgoing communications data from the portable communication device, incoming communications to the portable communication device, data stored on the portable communication device, and/or a location corresponding to communications made by and/or made to the portable communication device

17. The method of claim 14, wherein the portable communication device is a mobile telephone.

18. An application toolkit stored on a machine-readable medium on a subscriber identity module (SIM) card, wherein when the application toolkit is accessed by the SIM card and executed, causes the SIM card to interface with a portable communication device to:
track communication activity and/or location of the portable communication device;
store device-activity data representative of the tracked communication activity and/or device location of the portable communication device; and
upload the device-activity data to a remote device-activity server.
